(19) United States
(12) Patent Application Publication
(10) Pub. No.: US 2026/0131444 A1
(43) Pub. Date: May 14, 2026

(54) Guide tube for a power tool, power tool

(71) Applicant: Hilti Aktiengesellschaft, Schaan (LI)

(72) Inventors: Maximilian KNYRIM, Ehingen (DE); Steffen GEIGER, München (DE); Steffen MUCHA, Dirlewang (DE); Bernhard LIEBERT, Pfaffenhofen A.D. Glonn (DE); Andreas BARABANOV, Augsburg (DE)

(21) Appl. No.: 19/374,209

(22) Filed: Oct. 30, 2025

(30) Foreign Application Priority Data
Nov. 8, 2024 (EP) 24211604.4

(51) Int. Cl. B25D 17/06

(52) U.S. Cl. CPC B25D 17/06; B25D 2217/0019

(57) ABSTRACT

A guide tube for a power tool, in particular for a drill or chisel hammer, having a tubular main body made of steel and a reinforcing structure that surrounds the main body at least in sections on the outer circumference and is made of a material that has a lower density than steel. A power tool, in particular a drill or chisel hammer, having a guide tube according to the invention is also provided.

This claims priority to European Patent Application EP 24211604.4. filed on Nov. 8, 2024 which is hereby incorporated by reference herein.

The invention relates to a guide tube for a power tool, in particular for a drill or chisel hammer. Furthermore, the invention relates to a power tool, in particular a drill or chisel hammer, having a guide tube according to the invention.

### BACKGROUND

Drills and/or chisel hammers are well known. They have a striking mechanism with a striking piston for direct or indirect action upon a tool, such as a chisel. In a pneumatic striking mechanism, the striking piston is coupled, via an air spring, to an exciter piston, which moves the striking piston back and forth in the direction of striking. The striking piston and exciter piston are guided longitudinally in the direction of striking via a guide tube.

### SUMMARY OF THE INVENTION

The guide tube is exposed to high loads during operation of the power tool. These can lead to deformation of the guide tube. For example, the loads can lead to a bending of the pipe in the longitudinal direction and/or to a cross-sectional deformation, such that a formerly circular cross-section takes on the shape of an oval or an ellipse. In order to avoid such deformations, the guide tube is usually made of a high-strength material, such as steel. In order to increase the strength, in particular the dimensional rigidity, the wall thickness of the guide tube can also be increased. However, this also increases the weight of the guide tube. This is undesirable.

It is an object of the present invention to provide a guide tube that has the lowest possible weight, while maintaining sufficient dimensional stability.

The present invention provides a guide tube for a power tool, in particular for a drill or chisel hammer, having a tubular main body made of steel and a reinforcing structure that surrounds the main body at least in sections on the outer circumference and is made of a material that has a lower density than steel.

Due to the reinforcing structure arranged on the outer circumference, the wall thickness of the tubular steel main body can be reduced, so that it has a lower weight. Although the reinforcing structure adds weight, because it is made of a material with a lower density than steel, the weight increase due to the reinforcing structure is less than the weight savings achieved by the reduced wall thickness of the main body. At the same time, the reinforcing structure ensures the required dimensional stability of the guide tube.

The reinforcing structure is preferably made of aluminum or plastic, since in each case these materials have a lower density than steel and at the same time make a stable bond with the tubular main body made of steel possible. The guide tube can thus be designed in particular as a composite body. If the material is a plastic, it is suggested that it be a fiber-reinforced plastic in order to further increase the load-bearing capacity of the reinforcing structure made from it.

If the steel main body is combined with a plastic reinforcing structure, i.e., the guide tube is designed as a steel-plastic hybrid body, the main body assumes the guiding and sealing functions. Furthermore, it meets the thermal requirements placed on the guide tube.

The requirements for mechanical stability are met by the plastic reinforcing structure. The reinforcing structure is preferably connected to the main body in a force-fitting, form-fitting, and/or material-fitting manner. The force-fitting, form-fitting, and/or material-fitting connection between the main body and the reinforcing structure makes a strong bond possible and thus prevents any relative motion of the reinforcing structure with respect to the main body under load. For establishing a material-fitting connection, the tubular main body can be overmolded with the material for forming the reinforcing structure. At the same time, a form fit can be achieved due to undercut, shell-side recesses in the main body. The shell-side recesses can be subsequently introduced into the main body using a material-removing method, e.g., by laser machining, or can be formed directly during the production of the main body. A force-fitting connection between the main body and the reinforcing structure can be established using a press fit.

It is further provided that the reinforcing structure extend over at least 20%, preferably over at least 30%, further preferably over at least 50%, of the length of the main body. The arrangement of the reinforcing structure can be limited in particular to the regions of the main body that are particularly susceptible to deformation under load. This means that the reinforcing structure is preferably arranged substantially centrally in the axial direction, i.e., in the longitudinal direction of the guide tube. This also means that the reinforcing structure is spaced apart from the two ends of the main body.

Preferably, the reinforcing structure is designed to be tubular or in the form of ribs and/or grids. In the tubular design, the reinforcing structure can surround the main body in the manner of a sleeve. The tubular design provides maximum stabilization, but also requires the greatest use of material. For reducing the use of material and thus also the weight, the reinforcing structure can be designed in the form of ribs and/or grids, wherein the grid-like reinforcing structure is preferably achieved by intersecting ribs.

According to a preferred embodiment of the invention, the reinforcing structure has at least one rib extending substantially in the circumferential direction. The at least one rib extending substantially in the circumferential direction counteracts in particular a cross-sectional deformation of the tubular main body, so that the guiding function of the main body is ensured. For this purpose, the at least one rib extending in the circumferential direction is preferably designed to be circumferential. This means that it forms a closed ring that encloses the main body. Alternatively or additionally, it is provided that the at least one rib extending substantially in the circumferential direction have a pitch. If there is only one rib, it preferably extends around the main body like a spiral. For forming a grid-like reinforcing structure, the one rib can be combined with a further rib whose pitch is opposite to the pitch of the first rib. Furthermore, the reinforcing structure can have a plurality of ribs extending substantially in the circumferential direction, in each case with a pitch, wherein preferably the pitch of the ribs is the same, so that the distances between the ribs are the same. For forming a grid-like reinforcing structure, these ribs can then be combined with further ribs of opposite pitch.

Alternatively or additionally, it is provided that the reinforcing structure have a plurality of ribs extending substantially in the axial direction. The ribs, which extend substantially in the axial direction, particularly counteract bending of the tubular main body. This measure also serves to ensure the guiding function of the main body. Analogously to the ribs extending substantially in the circumferential direction, the ribs extending substantially in the axial direction can also have a pitch. The ribs with a pitch can then be used with further ribs that have an opposite pitch for forming a grid-like reinforcing structure. The opposite pitches can be selected such that they form an angle of 90° or less-for example, an angle of 45°.

Ribs extending in the axial direction are preferably arranged at the same angular distance relative to one another, so that the guide tube is evenly stiffened against bending around the circumference. In order to simplify the production of the ribs extending in the axial direction by means of overmolding, it is alternatively provided that the ribs be in each case aligned parallel to one another in groups. For example, four groups, in each case with a plurality of ribs extending in parallel, can be formed distributed around the circumference, so that the ribs opposite one another on the guide tube in each case can be demolded in a common direction. In total, only two demolding directions are required for the four groups.

Advantageously, the ribs extending in the axial direction are in each case beveled on at least one end. The guide tube can be mounted more easily via at least one beveled end of the ribs. In particular, the beveled ends can be used to achieve self-centering during assembly. Since the load on the guide tube usually decreases towards its ends, the beveled ends of the ribs do not have a negative effect on the dimensional stability of the guide tube. At the same time, the beveled ends allow material and weight to be saved upon.

According to a preferred embodiment of the invention, the main body has a wall thickness of 0.5 mm to 5 mm. Alternatively or additionally, it is provided that the reinforcing structure have a thickness of 1 mm to 5 mm. The wall thickness of the main body and the thickness of the reinforcing structure are in each case measured in the radial direction relative to the cross-section of the guide tube. As the thickness of the reinforcing structure increases, the wall thickness of the main body can be reduced. Preferably, the thickness of the reinforcing structure is greater than the wall thickness of the main body, since the reinforcing structure is made of a material with a lower density than steel, and thus maximum weight savings can be achieved.

In a further development of the invention, it is provided that the main body have at least one shell-side opening, which
a) is exposed through a gap or opening in the reinforcing structure or
b) opens into a channel formed in the reinforcing structure.

The at least one shell-side opening in the main body serves for air exchange during operation of the power tool. Therefore, the at least one opening is also referred to as a “breather hole.” In order not to impair the air exchange through the reinforcing structure, it is preferably arranged only where there is no such opening, so that the opening due to a non-existent reinforcing structure or a gap in the reinforcing structure is exposed. The gap and thus the exposure of the opening can also be achieved by a deliberately introduced opening into the reinforcing structure. Alternatively, a channel can be formed in the reinforcing structure, into which the opening of the main body serving for air exchange opens. The air can then be directed via the channel to a specific location, which ensures the necessary air exchange.

Furthermore, a power tool, in particular a drill or chisel hammer, is provided, having a guide tube according to the invention. Preferably, at least one piston of a striking mechanism is accommodated in the guide tube so as to be axially displaceable.

### BRIEF DESCRIPTION OF THE DRAWINGS

Preferred embodiments of the invention are described in more detail below with reference to the accompanying drawings. In the drawings:

FIG. 1 is a schematic representation of a power tool with a striking mechanism that comprises a guide tube,

FIG. 2 is a side view of a guide tube according to the invention for a power tool with a striking mechanism according to a first preferred embodiment of the invention,

FIG. 3 is a cross-section through the guide tube of FIG. 2,

FIG. 4 is a side view of a guide tube according to the invention for a power tool with a striking mechanism according to a second preferred embodiment of the invention,

FIG. 5 is a cross-section through the guide tube of FIG. 4,

FIG. 6 is a perspectival view of a guide tube according to the invention for a power tool with a striking mechanism according to a third preferred embodiment of the invention, and

FIG. 7 is a cross-section through the guide tube of FIG. 6.

### DETAILED DESCRIPTION

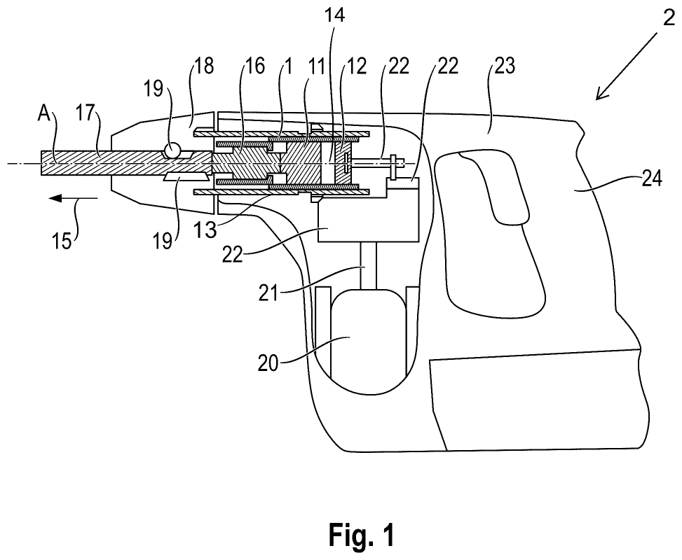

FIG. 1 shows a power tool 2 with a pneumatic striking mechanism 13. The striking mechanism 13 comprises a guide tube 1 for guiding a first piston 11, which is a striking piston, and a second piston 12, which is an exciter piston. Both pistons 11, 12 are coupled via an air spring 14. The exciter piston transmits via the air spring 14 a force acting in a direction of striking 15 to the striking piston. This in turn transmits the force to a striker 16, which transfers it to a tool 17 so that the tool 17 is driven forwards in the direction of striking. The tool 17 is accommodated in a tool holder 18 and fixed in the tool holder 18 by means of a locking device 19. Furthermore, a drive 20 is provided, which is connected via a shaft 21 to an eccentric drive 22, which converts the rotation of the shaft 21 into a translatory motion of the exciter piston 12. The power tool 2 shown in FIG. 1 also has a housing 23 having a handle 24 in order to hold the power tool 2 with the hands.

In a power tool 2 according to the invention, the guide tube 1 has a tubular main body 3 made of steel and a reinforcing structure 4 that surrounds the main body 3 on the outer circumference, at least in sections, and is made of a material that has a lower density than steel. The material can in particular be aluminum or plastic.

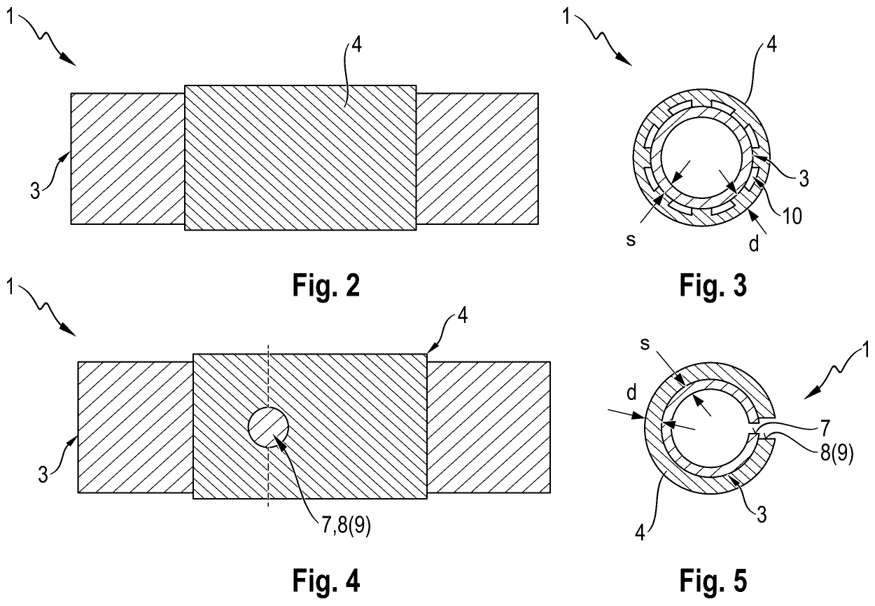

As shown by way of example in FIGS. 2 and 3, the reinforcing structure 4 can be designed to be tubular. In order to achieve a firm bond between the main body 3 and the reinforcing structure 4, the tubular reinforcing structure 4 can be pressed onto the main body 3. Alternatively, the main body 3 can be overmolded with the material of the reinforcing structure 4. In the present case, the reinforcing structure 4 has a shorter length than the main body 3. As a result, material and weight can be saved upon. Since the center of the guide tube 1 is subjected to the greatest bending stress during operation of the power tool 2, the reinforcing structure 4 is arranged centrally in relation to the main body 3.

Thanks to the reinforcing structure 4, the wall thickness of the main body 3 can be reduced, so that weight is saved upon as a result. This is because the material of the reinforcing structure 4 has a lower density than the material of the main body 3. In FIG. 3, the main body 3 therefore has a wall thickness s that is smaller than a thickness d of the reinforcing structure 4.

As can also be seen in FIG. 3, the reinforcing structure 4 forms channels 10 that extend in the longitudinal direction of the guide tube 1. The channels 10 serve for the necessary air exchange between the striking mechanism 13 and the air spring 14. Therefore, the air exchange must not be impeded by the reinforcing structure 4.

As shown by way of example in FIGS. 4 and 5, the air exchange can also be ensured by a gap 8 or opening 9 of the reinforcing structure 4, which is arranged in overlap with an opening 7 of the main body 3.

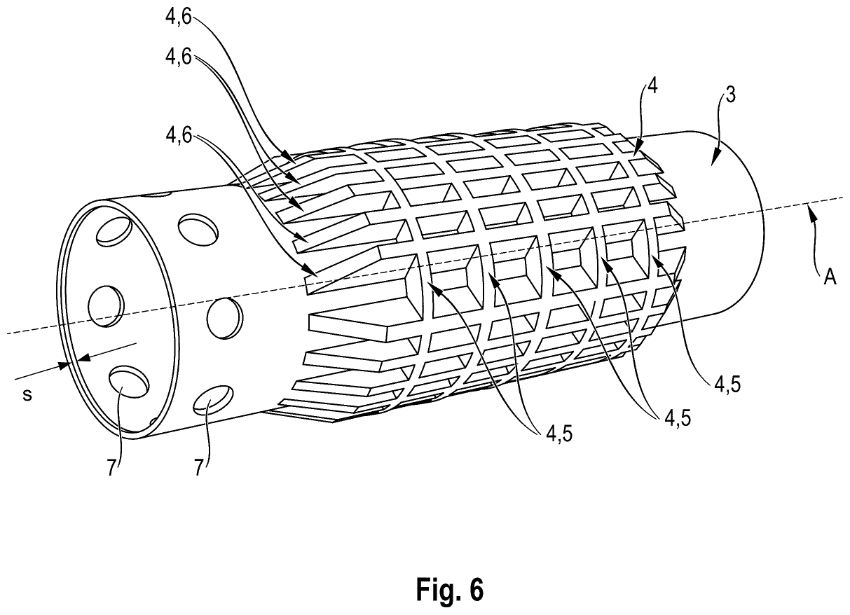

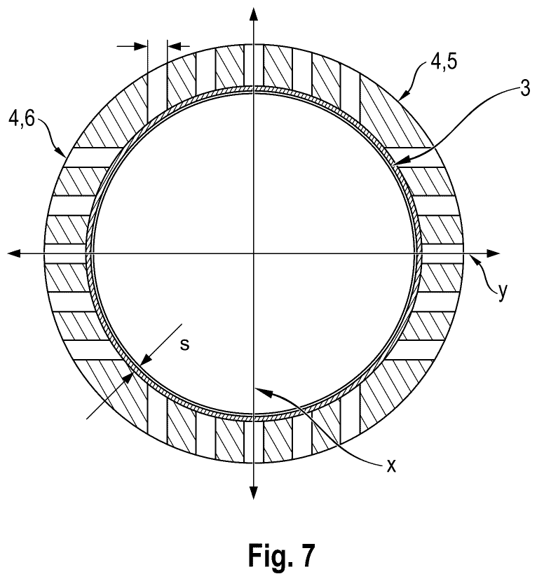

A further preferred embodiment of a guide tube according to the invention is shown in FIGS. 6 and 7. In this embodiment, the reinforcing structure 4 is designed in the form of grids. The grid is formed by first ribs 5, which extend around the main body 3 in the circumferential direction, i.e., enclose the main body 3 in a ring shape. The ribs 5 are arranged at regular intervals relative to one other. The grid is further formed by second ribs 6, which run in the longitudinal direction or parallel to a longitudinal axis A of the guide tube 1 and are distributed around the circumference of the main body 3 in such a way that four groups of five ribs 6 are formed in each case, which in each case run parallel to one another (see in particular FIG. 7). This type of grouping of the ribs 6 facilitates the production of the reinforcing structure 4 by overmolding, since the workpiece can be easily demolded along the two axes x, y.

The ribs 5, which extend in the circumferential direction, counteract cross-sectional deformation of the main body 3 under load. The ribs 6 extending in the longitudinal direction prevent the main body 3 from bending under load. In order to facilitate the assembly of the guide tube 1, the ribs 6 are beveled at their end sides. In addition, the end-side beveling of the ribs 6 results in further material and weight savings without compromising the dimensional stability of the guide tube 1. This is because the load on the guide tube 1 towards its ends is significantly lower than in the middle.

The main body 3 of the guide tube 1 in FIGS. 6 and 7 also has openings 7 that serve for air exchange. Since the openings 7 are arranged in an end section of the main body 3, they are not covered by the reinforcing structure 4.

### LIST OF REFERENCE SIGNS

1 Guide tube
2 Power tool
3 Main body
4 Reinforcing structure
5 Rib
6 Rib
7 Opening
8 Gap
9 Opening
10 Channel
11 Piston
12 Piston
13 Striking mechanism
14 Air spring
15 Direction of striking
16 Striker
17 Tool
18 Tool holder
19 Locking device
20 Drive
21 Shaft
22 Eccentric drive
23 Housing
24 Handle
s Wall Thickness
d Thickness
A Longitudinal axis
x Axis
y Axis

What is claimed is:

1. A guide tube for a power tool, the guide tube comprising:
a tubular main body made of steel and having an outer circumference; and
a reinforcing structure surrounding the main body at least in sections on the outer circumference and made of a material having a lower density than steel.

2. The guide tube as recited in claim 1 wherein the reinforcing structure is connected to the main body in a force-fitting, form-fitting, or material-fitting manner.

3. The guide tube as recited in claim 1 wherein the reinforcing structure extends over at least 20% of a length of the main body.

4. The guide tube as recited in claim 1 wherein the reinforcing structure extends over at least 30% of a length of the main body.

5. The guide tube as recited in claim 1 wherein the reinforcing structure extends over at least 50% of a length of the main body.

6. The guide tube as recited in claim 1 wherein the reinforcing structure is tubular or in the form of ribs or grids.

7. The guide tube as recited in claim 1 wherein the reinforcing structure has least one rib extending in a circumferential direction.

8. The guide tube as recited in claim 7 wherein the at least one rib is formed circumferentially or has a pitch.

9. The guide tube as recited in claim 1 wherein the reinforcing structure has a plurality of ribs extending in an axial direction, which are preferably arranged at the same angular distance relative to one another or aligned parallel relative to one another in groups.

10. The guide tube as recited in claim 9 wherein the plurality of ribs are arranged at a same angular distance relative to one another or aligned parallel relative to one another in groups.

11. The guide tube as recited in claim 9 wherein the ribs are in each case beveled on at least one end.

12. The guide tube as recited in claim 1 wherein the main body has a wall thickness of 0.5 mm to 5 mm.

13. The guide tube as recited in claim 1 wherein, the reinforcing structure has a thickness of 1 mm to 5 mm.

14. The guide tube as recited in claim 1 wherein the main body has at least one shell-side opening:
a) exposed through a gap or opening of the reinforcing structure or
b) opening into a channel formed in the reinforcing structure.

15. The guide tube as recited in claim 1 wherein the guide tube is a drill or chisel hammer guide tube.

16. A power tool comprising the guide tube according to claim 1.

17. The power tool as recited in claim 16 further comprising at least one piston of a striking mechanism accommodated in the guide tube so as to be axially displaceable.

18. A drill or chisel hammer comprising the power tool as recited in claim 16.
